(19) United States
(12) Patent Application Publication
(10) Pub. No.: US 2004/0090948 A1
(43) Pub. Date: May 13, 2004

(54) Method in a communications system for assigning transmission resources

(76) Inventors: Mika Forssell, Espoo (FI); Janne Parantainen, Helsinki (FI)

Correspondence Address: HARRINGTON & SMITH, LLP, 4 RESEARCH DRIVE, SHELTON, CT, 06484-6212, US

(21) Appl. No.: 10/451,614

(22) PCT Filed: Dec. 13, 2001
(86) PCT No.: PCT/FI01/01094

(30) Foreign Application Priority Data
Dec. 20, 2000 (FI) 20002810

(51) Int. Cl. H04B 7/212; H04L 12/413; H04L 12/66

(52) U.S. Cl. 370/349; 370/449; 370/352

(57) ABSTRACT

A GPRS system comprises a plurality of mobile terminals and a GPRS network. In order to obtain uplink radio resources, the mobile terminals send channel requests to the network and receive control blocks in return. The control blocks contain a number of fields, one of which, the uplink state flag field, contains the sending permissions. In order to extend the numbering space of the uplink state flag field, unused bits present in another field are used.

The invention relates to a communications system and is particularly, but not exclusively, related to a wireless communications system such as a cellular telephone system. In one embodiment, it relates to a General Packet Radio Service (GPRS) based system and concerns the transmission of data and commands over the air interface between a mobile station and a GPRS network.

There are fundamental differences in the requirements for data communication and for speech communication. For speech communication, which is a real time service, delay requirements are higher. For data communication delay constraints are lower but error requirements are higher. The use of packet data protocols, which are more suitable for transmission of data than circuit switched protocols, are being used cellular communication systems.

At the moment, cellular communications systems generally provide a circuit switched data service which can be used to interconnect with external data networks. Packet switched data services have been proposed, in particular GPRS. GPRS is introduced as a part of GSM (Global System for Mobile Communications) and parts of the GSM infrastructure are used. It allows for packet switched communication, for example Internet Protocol (IP), or virtual circuit switched communication. GPRS supports connectionless protocols (for example IP) as well as a connection-oriented protocol (X.25). One of the advantages with a packet switched data communication protocol is that a single transmission resource can be shared between a number of users. Thus, in the case of a cellular system such as GSM, a timeslot on a radio frequency carrier can be utilised by several mobile users for reception and transmission of data. The shared transmission resource is managed by the network side of the cellular system both for downlink and uplink transmissions.

An advantage of introducing a packet data protocol in cellular systems is the ability to support high data rate transmissions and at the same time achieve a flexibility and efficient utilisation of the radio frequency bandwidth over the radio interface. The concept of GPRS is designed for so-called “multislot operations” where a single user is allowed to occupy more than one transmission resource simultaneously.

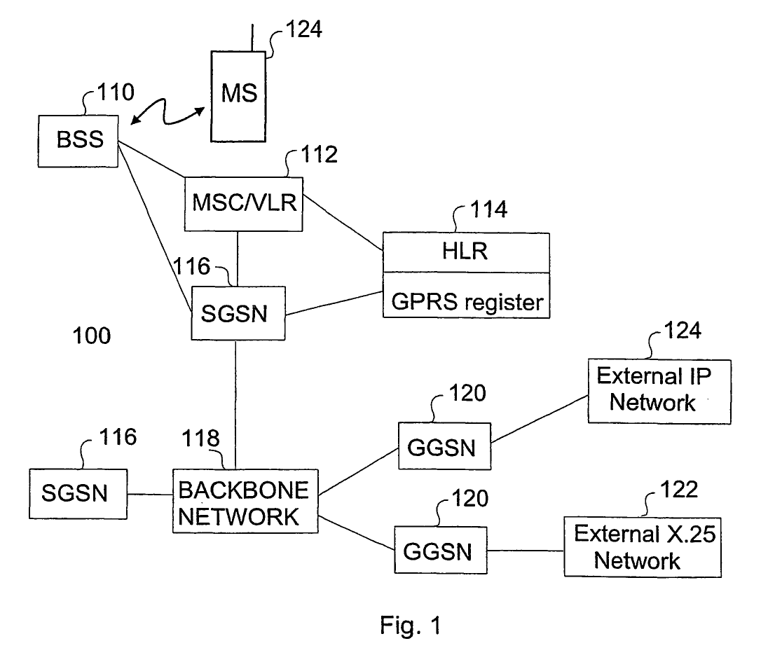

The GPRS network architecture is shown in FIG. 1. Information packets from external networks 122, 124 enter the GPRS network at a GGSN (Gateway GPRS Service Node) 120. The packets are then routed from the GGSN via a backbone network 118, to a SGSN (Serving GPRS Support Node) 116 that is serving the area in which the addressed GPRS mobile resides. From the SGSN the packets are routed to the correct BSS (Base Station System), in a dedicated GPRS transmission. The BSS communicates with a mobile stations (MS) 126 over the air interface. A GPRS register 115 holds all subscription data of GPRS MSs. The GPRS register may, or may not, be integrated with the HLR (Home Location Register) 114 of the GSM system. Subscriber data may be interchanged between the SGSN and the MSC to ensure service interaction, such as restricted roaming of MSs.

The GPRS network may be connected to an external IP network such as the Internet.

Communication over the GPRS based system is based upon time division multiple access (TDMA) which, together with GPRS based systems generally, is well known to those skilled in the art.

In use, an MS may be connected (whether by a wired or a wireless connection) to a data processing device such as a laptop. The MS may be used by the data processing device to send data. The data processing device may be used to surf the Internet, to send email or to communicate with a public or a private network.

The technical standard on which GPRS is based is evolving and two technical standards have been standardised. The first technical standard is GPRS Release 1997 which provides basic data services. The second technical standard is Enhanced GPRS Release 1999 which provides higher data rates than GPRS Release 1997. GPRS and EGPRS are collectively referred to as (E)GPRS in the following. It has been proposed to standardise a third version of the technical standard, GSM/EDGE/Radio Access Network Release 2000 (referred to as GERAN in the following).

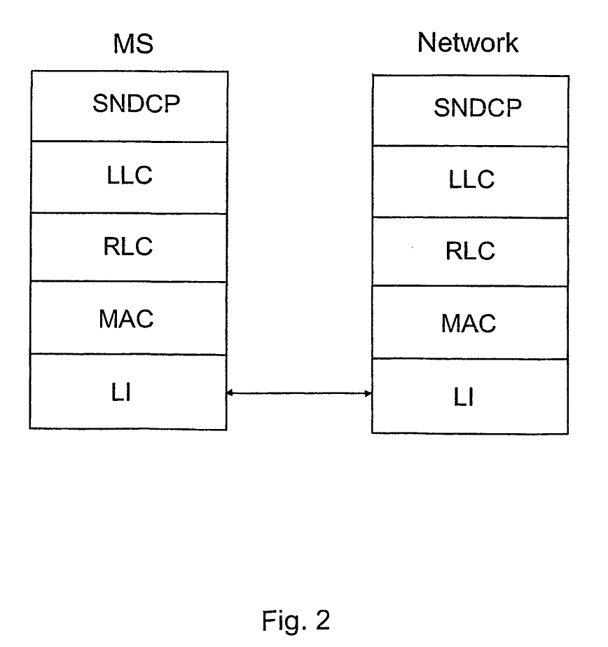

The MS and the network in (E)GPRS have corresponding protocol stacks as shown in FIG. 2. The layers of the protocol stacks are a subnetwork dependent convergence protocol (SNDCP) layer, a logical link control (LLC) layer, a radio link control (RLC) layer, a medium access control (MAC) layer and a physical layer L1. In GERAN, the SNDCP layer and the LLC layer are replaced by a packet data convergence protocol layer (PDCP). The operation and use of the protocol stacks is explained in greater detail in documents WO 99/09724 and WO 00/54464 which are hereby incorporated by reference.

Operation of an (E)GPRS based system will now be described. Once a packet data protocol (PDP) context has been activated between an MS and a network, uplink transmission from the MS to the network and downlink transmission from the network to the MS may occur. In the transmitting side, whether the MS or the network, the SNDCP layer carries out compression and other functions, the LLC layer packages data into LLC protocol data units (PDUs) having an LLC header and data, the RLC layer buffers the LLC PDUs and segments each into RLC data blocks and the MAC layer arranges for transmission and reception of the RLC data blocks over the L1 layer. In the receiving side, these activities are carried out in a corresponding reverse order. In addition to the transmitting of RLC data blocks, RLC/MAC control blocks are transmitted between the network and MSs. RLC/MAC control blocks control RLC/MAC transfer specific information such as acknowledgement bitmaps and radio resource assignments. In the following, RLC data blocks and RLC/MAC control blocks are collectively referred to as RLC/MAC blocks. Downlink RLC/MAC blocks comprise a MAC header having, among other fields, a three bit uplink state flag (USF) field, a relative reserved block period (RRBP) field and a supplementary polling (S/P) field. The use of these fields will be described in the following. If the S/P field is set to 1, the RRBP field is valid and the MS receiving the RLC/MAC block is polled for acknowledgement of received blocks. If the S/P field is set to 0, the RRBP field is invalid. The MAC header is followed by the RLC part having its own header which contains, among other fields, a temporary flow identity (TFI) field. Depending on whether the RLC/MAC block is an RLC data block or an RLC/MAC control block, it contains either RLC data or a control message.

Uplink RLC data blocks comprise a MAC header. The MAC header is followed by the RLC part having its own header which contains, among other fields, a TFI field. The RLC part contains RLC data. Uplink RLC/MAC control blocks comprise a MAC header followed by a control message.

Although other fields are present in both RLC data blocks and RLC/MAC control blocks, they are not described since they are not required in order for the prior art and the invention to be understood.

In the uplink direction, the MAC layer multiplexes RLC/MAC blocks from different MSs onto a single channel. This is done by the network allocating sending permissions on the channel to the MSs. In (E)GPRS there are two main MAC allocation modes for allocating the sending permissions, fixed allocation and dynamic allocation. These allocation modes are controlled by the transmission of RLC/MAC blocks in the downlink direction. In fixed allocation, the network assigns all sending permissions to the MSs. These assignments are sent in a transmission bitmap. In dynamic allocation the network assigns sending permissions to the MSs for each uplink transmission in turn in each RLC/MAC block it sends. The following is concerned with dynamic allocation.

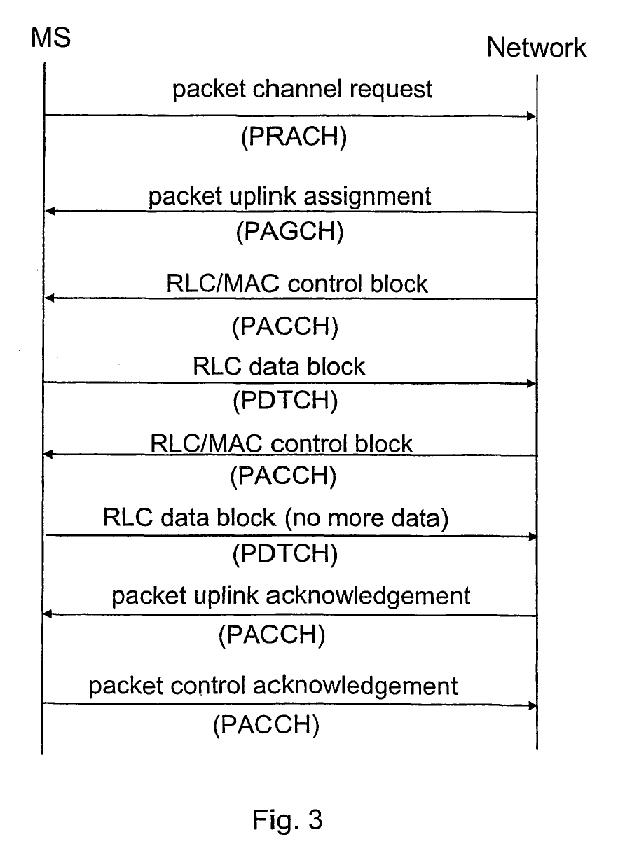

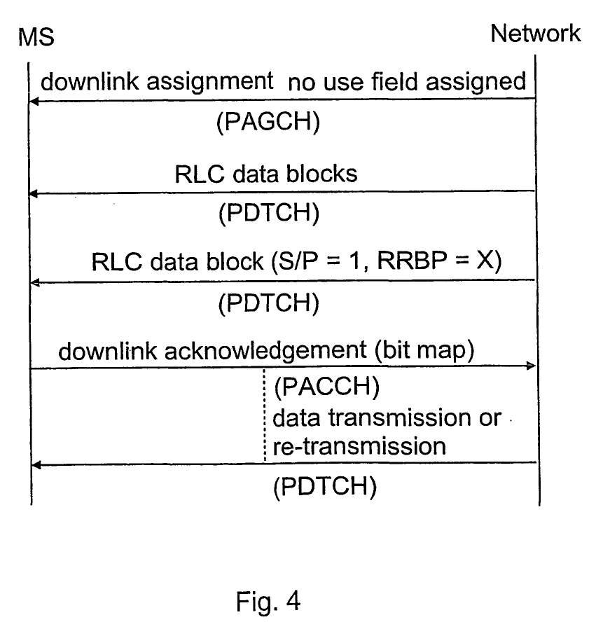

FIGS. 3 and 4 are signalling charts showing the signals or messages which are sent between the MS and the network.

FIG. 3 describes uplink LLC PDU transfer and FIG. 4 describes downlink LLC PDU transfer. These Figures describe the case of dynamic allocation in which the network assigns sending permissions. In GPRS based systems, a sending permission relates to a radio block and refers to the occupation of four consecutive turns of a particular time slot in a series of four TDMA frames. There are typically eight time slots in a frame and a sending permission relates to, for example, time slot number seven being used four times in a row to transmit RLC/MAC blocks. One particular time slot typically represents one packet data channel (PDCH).

It should be understood that there can be a plurality of uplink PDU transmission operations in existence between the network and a plurality of MSs at one time. A new PDU transmission operation may be started whilst other PDU transmission operations are pre-existing. Starting of such a new PDU transmission operation will now be described for both uplink and downlink. In the following, for the sake of simplicity, an uplink PDU transmission operation is only described from the perspective of one particular MS. However, it should be understood that RLC/MAC blocks may be transmitted between other MSs and the network at times between the transmission of individual RLC/MAC blocks which is described in the following.

Referring now to FIG. 3, a particular MS sends a packet channel request to the network requesting an uplink resource. The request is sent on the packet random access channel (PRACH). The uplink resource comprises a temporary block flow (TBF) which is a unidirectional connection from the MS to the network. The network responds to the packet channel request by sending a packet uplink assignment message. This message is sent on the packet access grant channel (PAGCH). The packet uplink assignment message includes a list of PDCHs assigned to the MS. A PDCH can be used either as a packet data traffic channel (PDTCH) on which the MS may send data or as a packet associated control channel (PACCH) on which the network may send control messages. The packet uplink assignment message also includes the corresponding USF values for each of the PDCHs. A unique TFI identifying the TBF is allocated by the network to the MS and is thereafter included in each RLC data block sent by the MS to the network related to that TBF so that the network knows to which TBF the packet belongs.

The MS monitors its allocated PDCHs whilst the network sends downlink RLC/MAC blocks on the allocated PDCHs. These blocks may be destined for any MS camping on the PDCHs. As described above, a downlink RLC/MAC block includes a MAC header and an RLC part. The MAC header contains a USF and the RLC part includes a TFI. The TFI indicates which MS is to receive and to interpret the RLC part. The USF indicates which MS may transmit data on uplink. The USF and the TFI may relate to the same or to different MSs. The MS indicated by the USF then transmits its data to the network in RLC data blocks in the next available radio block.

Transmission of RLC data blocks continues until the MS has transmitted the last piece of its LLC PDU and has notified the network that there are no more RLC data blocks to be sent. In this case, if the network has received all of the RLC data blocks, it sends a packet uplink acknowledgement having a MAC header containing a valid RRBP field which indicates an uplink sending permission assigned by the network. This is the time when the MS is to transmit a packet control acknowledgement to acknowledge the reception of the packet uplink acknowledgement message. The MS responds by transmitting the packet control acknowledgement in the uplink sending permission indicated in the RRBP field. The uplink TBF for the particular MS ends.

After the complete transmission of the LLC PDU from the MS, the network can continue to receive RLC data blocks from the other MSs and acknowledge receipt of LLC PDUs from them.

Referring now to FIG. 4, the network transmits a downlink assignment on the packet access grant channel (PAGCH) to a particular MS. The downlink assignment contains a number of PDCHs which are allocated to that MS and an address field which indicates to the MS that the downlink assignment is for it. The address in the address field may either be a previously assigned uplink TFI or a temporary logical link identity (TLLI). Based on information present in the downlink assignment, the MS starts to monitor the assigned PDCHs. In contrast to the uplink transmission, no USF field is provided in the downlink assignment since the network decides internally which MS is to receive the next RLC data block and then transmits it on the assigned PDTCH. The network uses an appropriate TFI in the RLC data block to address the MS. The RLC data in the form of one or more RLC data blocks is then transmitted by the network to the MS. Periodically, an RLC/MAC block is transmitted in which the S/P field is set to 1 and thus the value of the RRBP field (in this example X) defines a time when the MS is to transmit a block in response to the polling. In response, the MS transmits a downlink acknowledgement message providing a bit map indicating which data blocks have been received and which have not. Further data transmission or re-transmission can subsequently occur as necessary. The last downlink RLC data block to be transmitted contains a valid RRBP and a final block indicator (FBI) bit set to 1.

In dynamic allocation in (E)GPRS, in order to make efficient use of radio resources in the uplink direction, the network may allocate at maximum eight uplink temporary block flows (TBFs) to the same PDCH in order to multiplex up to eight MSs onto that PDCH. USFs are used to identify which MSs have sending permission. When an MS is sending RLC data blocks in the uplink direction, for example in the situation described above in relation to FIG. 3, the network indicates in the USF field of downlink RLC/MAC control blocks which of the TBFs is permitted next to send data in the uplink direction. Since the USF field is only three bits long, the USF is able to indicate only eight TBFs (in practice, one particular USF value is not assigned to a TBF since it may be needed in order to be able to poll an MS for a downlink acknowledgement). In (E)GPRS, allowing only eight TBFs is not a problem since an MS may have only one TBF per direction (for example one TBF in the uplink direction). However, in GERAN, it has been proposed that an MS may have several TBFs in each direction. This increases the need to have more USF numbering space.

According to a first aspect of the invention there is provided a method of communicating between a plurality of terminals and a communications network, the method comprising the steps of:

receiving a request from at least one of the terminals for transmission resources from the communications network;

assigning the transmission resources; and

sending a block having a plurality of data fields from the communications network to at least one of the terminals the block comprising a sending permission to indicate which of the terminals is permitted to send data to the communications network,

characterised in that the sending permission has a first part present in a first field of the block and a second part present in second field of the block.

Preferably the steps of receiving, assigning and sending occur within an RLC/MAC protocol stack. Preferably they occur within the MAC layer of such a stack.

According to a second aspect of the invention there is provided a method of operating a terminal to communicate with a communications network, the method comprising the steps of:

requesting transmission resources from the communications network;

receiving an assignment of the transmission resources; and

receiving a block having a plurality of data fields the block comprising a sending permission to permit the terminal to send data to the communications network,

characterised in that the sending permission has a first part present in a first field of the block and a second part present in second field of the block.

Preferably the steps of requesting resources, receiving an assignment and receiving a block occur within an RLC/MAC protocol stack. Preferably they occur within the MAC layer of such a stack.

According to a third aspect of the invention there is provided a communications network for communicating with a plurality of terminals, wherein at least one of the terminals requests transmission resources from the communications network and the communications network sends a block having a plurality of data fields to the at least one of the terminals the block comprising a sending permission to assign the transmission resources and to permit the at least one of the terminals to send data to the communications network,

characterised in that the sending permission has a first part present in a first field of the block and a second part present in second field of the block.

Preferably the network has a protocol stack which generates the two part sending permission. Preferably the network has an RLC/MAC protocol stack.

According to a fourth aspect of the invention there is provided a computer program product for operating a communications network, the communications network communicating with a terminal, the computer program product comprising a computer readable medium having thereon:

computer executable code means to enable the communications network to receive a request for transmission resources from the terminal;

computer executable code means to enable the communications network to assign the transmission resources; and

computer executable code means to enable the communications network to send a block having a plurality of data fields to the terminal the block comprising a sending permission to permit the terminal to send data to the communications network,

characterised in that the computer program product comprises computer executable code means to enable the communications network to send the sending permission in two parts, a first part present in a first field of the block and a second part present in second field of the block.

Preferably the network comprises a processor for running computer executable code to generate the protocol stack.

According to a fifth aspect of the invention there is provided a communications system comprising a plurality of terminals and a communications network for communicating with the plurality of terminals, wherein at least one of the terminals requests transmission resources from the communications network and the communications network sends a block having a plurality of data fields to the at least one of the terminals the block comprising a sending permission to assign the transmission resources and to permit the at least one of the terminals to send data to the communications network,

characterised in that the sending permission has a first part present in a first field of the block and a second part present in second field of the block.

According to a sixth aspect of the invention there is provided a terminal for communicating with a communications network, wherein the terminal requests transmission resources from the communications network and the communications network sends a block having a plurality of data fields to the terminal the block comprising a sending permission to assign the transmission resources and to permit the terminal to send data to the communications network,

characterised in that the sending permission has a first part present in a first field of the block and a second part present in second field of the block.

Preferably the terminal has a protocol stack which interprets the two part sending permission to determine a single sending permission and then sends data to the network in accordance with the sending permission. Preferably the terminal has an RLC/MAC protocol stack.

Preferably the terminal comprises a processor for running computer executable code to generate the protocol stack.

According to a seventh aspect of the invention there is provided a computer program product for operating a terminal to communicate with a communications network, the computer program product comprising a computer readable medium having thereon:

computer executable code means to enable the terminal to send a request for transmission resources from the communications network;

computer executable code means to enable the terminal to receive an assignment of the transmission resources from the communications network; and

computer executable code means to enable the terminal to receive a block having a plurality of data fields from the communications network the block comprising a sending permission to permit the terminal to send data to the communications network,

characterised in that the computer program product comprises computer executable code means to enable the terminal to receive the sending permission in two parts, a first part present in a first field of the block and a second part present in second field of the block.

Preferably the transmission resources are radio resources. The resources may be requested by sending a channel request. Preferably the channel request is sent to the communications network in an uplink path.

Preferably assignment of the transmission resources is notified to the terminal by sending an assignment block from the communications network to the terminal in a downlink path.

Preferably following assignment of the transmission resources, a downlink block is sent. Preferably the block is a downlink data block. This is a block used primarily to transfer data. Alternatively it may be a downlink control block. This is a block used primarily to control the terminal. In each case, blocks may both transfer some data and exercise some control. Preferably the block is a MAC block.

Preferably the terminals and the communications network communicate over an air interface. Preferably the communication over the air interface is controlled by the communications network periodically polling the terminals to send acknowledgements of receipt of blocks transmitted by the communications network.

Preferably the first part of the sending permission is sent in a field specifically intended for that information. In one embodiment, this field is an uplink state flag field in a MAC header of the block. The first part may be in the uplink state flag field of a downlink RLC/MAC block.

Preferably the second part of the sending permission is sent in a field which is not specifically intended for that information. It may be sent in a field which is used to send specific information occasionally and is unused at other times. In one embodiment, this field is a MAC header of the block. The second part may be in the RRBP field of the MAC header of a downlink RLC/MAC block. Alternatively the second part of the sending permission is in an RLC header of the block. In this case, it may be in a specially created field.

Preferably the terminals are mobile terminals. They may be radio telephones.

The terminals and the communications network may communicate according to TDMA.

According to an eighth aspect of the invention there is provided a method of communicating between a terminal and a communications network, the method comprising the step of sending a block having a plurality of data fields from the communications network to the terminal, the block containing an instruction,

characterised in that the instruction has a first part present in a first field of the block and a second part present in second field of the block wherein the second field is used occasionally to send specific information other than the second part of the instruction and is not used at other times to send the specific information and the second part is sent when the second field is not used to send the specific information.

According to further aspects of the invention, there may be provided a communications network, a communication system, a terminal, and a computer program product corresponding to the eighth aspect of the invention.

Preferably the invention relates to a packet data communication system. It may relate to a packet radio system, for example a GPRS based system. It may relate to a GPRS, an (E)GPRS or a GERAN based system.

Preferably the invention relates to allocation of dynamic transmission resources.

It should be noted that in one embodiment of the invention, its functional parts are present in the transmission part of a communications network and in the reception part of a terminal. Therefore, in a wireless system, it may be present in the downlink path.

Embodiments of the invention will now be described by way of example only with reference to the accompanying drawings in which:

FIG. 1 shows a GPRS based system;

FIG. 2 shows corresponding protocol stacks in a mobile station and in a network;

FIG. 3 shows a signalling chart of the signals which occur when the mobile station requests radio resource from the network; and

FIG. 4 shows a signalling chart of the signals which occur when the network seeks to establish a connection to the mobile station.

The above Figures have been described in connection with the prior art. The same Figures will now be used to describe the invention.

The invention is concerned with dynamic allocation in a GPRS based network in which a MS monitors RLC/MAC blocks transmitted on a downlink channel to determine whether it is permitted to use the next available radio block on the uplink channel.

The invention is an improvement to the system and methods described in the foregoing in relation to the prior art. The difference provided by the invention is that (E)GPRS and GERAN MSs interpret some of MAC header fields, such as the RRBP field, in a different way. Additionally, the network transmits RLC/MAC blocks of a first type to (E)GPRS MSs and of a second type to GERAN MSs. As a result of the different way in which the GERAN MSs interpret their RLC/MAC blocks, the USF numbering space is extended. This is done by providing additional USF bits in RLC/MAC blocks. Two methods of doing this are described in the following.

The first method in which the USF numbering space may be extended for GERAN MSs will now be described. As described in the foregoing, downlink RLC/MAC blocks have a number of different fields in their MAC headers. The USF value in the USF field indicates which MS assigned to a PDCH is permitted to send RLC/MAC blocks in the next available uplink sending permission. The RRBP field defines a time when an MS is scheduled to transmit its packet downlink acknowledgement acknowledging receipt of RLC/MAC blocks. This packet downlink acknowledgement only needs to be sent periodically, for example only in one in ten or one in twenty uplink RLC/MAC blocks, since the MS is able to acknowledge a number of RLC/MAC blocks at the same time. The S/P field indicates whether the RRBP field is valid or invalid. It is set to 1 if the RRBP field is valid and is set to 0 if the RRBP field is invalid. Since the S/P field is only occasionally set to 1, there are a number of RLC/MAC blocks containing invalid RRBP fields which are not being used. Therefore, in the invention, for GERAN MSs, when the RRBP field is not being used to define a polling response time, that is when there are “free” RRBP bits, the RRBP field is used to provide extra bits for the USF and is thus used to increase its numbering space. (E)GPRS MSs interpret the USF field according to the prior art and so they can only use conventional three bit USFs. However, it should be noted that the system according to the invention provides a way for both GERAN MSs and (E)GPRS MSs to use three bit USF values and for GERAN MSs to use five bit USF values.

This will now be described in greater detail. In transmitting downlink RLC/MAC blocks to GERAN MSs, on occasions on which the S/P field is set to 0 and the RRBP is invalid, the RRBP field is used to define the two most significant bits (MSBs) and the USF field is used to define the three least significant bits (LSBs) of the USF. The bits of such an extended USF are X₅X₄X₃X₂X₁ where X₅ is the MSB of the RRBP, X₄ is the LSB of the RRBP, X₃ is the third USF bit (the MSB), X₂ is the second USF bit and X₁ is the first USF bit (the LSB). In this way, the MS is allocated a five bit USF.

GERAN and other MSs having a USF of the form 00X₃X₂X₁ can be addressed at any time as will now be described. When the S/P field is set to 1 (in which case the RRBP field is valid and defines a polling response time), only the USF field in the MAC header contains valid USF information. In this case the GERAN MS preferably considers the two MSBs of the five bit USF (the RRBP field) both as 0. In this case, the USF has the form 00X₃X₂X₁ (where the X bits can take any permitted values). In this case the network can only address MSs within the USF numbering space 0 to 7. This means that, for example, a MS having a USF of the form 11X₃X₂X₁ (such as 11000) allocated as its TBF is not allowed to transmit an uplink RLC/MAC block in response to an RLC/MAC block containing a valid RRBP field (when the S/P field is set to 1) and so the network must do one of the following:

not allocate any uplink resource at all (for example by using an unallocated USF);

allocate uplink resource to an (E)GPRS MS; or

allocate uplink resource to a GERAN MS having a USF of the form 00X₃X₂X₁.

The network can be configured to choose an appropriate USF in this case. Another possibility is that if the S/P field is set to 1, GERAN MSs are configured to ignore the downlink RLC/MAC blocks. In this case, only (E)GPRS MSs can be scheduled uplink sending permissions.

When the S/P field is set to 0, the network is able to address GERAN MSs having a USF value above 7.

In an embodiment in which (E)GPRS and GERAN MSs are to be multiplexed onto one particular PDCH, it is possible to reserve one of the three USF bits and to use it as an indicator bit to define whether the USF is for (E)GPRS or GERAN MSs. For example, the third bit of the USF field may be used for this purpose such that for (E)GPRS MSs it is set to 0 and for GERAN MSs it is set to 1. Therefore, on the particular PDCH, for (E)GPRS MSs the USF numbering space is defined by two bits and so USF values 000, 001, 010, 011 may be allocated for these MSs. For GERAN MSs, the USF numbering space is defined by X₁X₂1X₄X₅ and so sixteen USF values may be allocated for these MSs on the particular PDCH. In this way the USF numbering space for a combination of GERAN and (E)GPRS MSs may be more than double that available according to the prior art. In the prior art, a numbering space of 0 to 7 is available on one PDCH. In the case in which the downlink RLC/MAC block contains a valid RRBP field (the MS is polled), only three of the USF bits define which MS can transmit next, for example if the bits of the USF are 001, a (E)GPRS MS having a USF value of 001 can transmit and if the bits of the USF are 101 a GERAN MS having USF value of 00101 can transmit.

The usage of an indicator bit is network dependent and may be omitted if circumstances permit. For example, it may be omitted if a PDCH contains mostly or only (E)GPRS MSs in order to allow the network to use all three USF bits for those MSs and maximise the number of (E)GPRS MSs which can use the same PDCH. A disadvantage of this approach is that extension bits cannot be used to increase the USF numbering space and thus only eight USF values are available on each PDCH. Alternatively, the indicator bit may be omitted if a PDCH contains mostly or only GERAN MSs in order to allow the network to use all five USF bits for those MSs and maximise the number of GERAN MSs which can use the same PDCH. Having an indicator bit provides a good balance between having, for example, four (E)GPRS and sixteen GERAN MSs on the same PDCH. Irrespective of whether an indicator bit is used, if the S/P field is set to 1, only three USF bits are useable and only seven MSs (whether (E)GPRS or GERAN) are able to share the PDCH at that time.

The second method in which the USF numbering space may be extended for GERAN MSs will now be described. In this case, an extra field in the downlink RLC/MAC block is defined. This is done by extending the RLC header to include an extra field of N bits (for example N equals two) to provide additional USF bits. The USF field and the extra field are used to extend the USF numbering space in a way similar to that described above in relation to the first method. An advantage of the second method is that it is not dependent on the availability of “free” RRBP bits. A disadvantage of the second method is that the extended USF numbering space can only be used when GERAN MSs receive RLC/MAC blocks containing the extended USF field. RLC/MAC blocks sent to a (E)GPRS MS cannot contain this extra field. Thus, for (E)GPRS MSs, conventional RLC/MAC blocks must be sent to MSs.

By increasing the USF numbering space, more TBFs can be allocated to a PDCH. This is important for GERAN MSs because it is intended that they will be allowed to have several uplink TBFs and currently only eight TBFs on a PDCH can be addressed with a USF value due to the current availability of three USF bits. The invention does this by using “free” RRBP bits or additional field bits to increase the USF numbering space.

Particular implementations and embodiments of the invention have been described. It is clear to a person skilled in the art that the invention is not restricted to details of the embodiments presented above, but that it can be implemented in other embodiments using equivalent means without deviating from the characteristics of the invention. The scope of the invention is only restricted by the attached patent claims.

1. A method of communicating between a plurality of terminals and a communications network, the method comprising the steps of:
receiving a request from at least one of the terminals for transmission resources from the communications network;
assigning the transmission resources; and
sending a block having a plurality of data fields from the communications network to at least one of the terminals the block containing a sending permission to indicate which of the terminals is permitted to send data to the communications network,
characterised in that the sending permission has a first part present in a first field of the block and a second part present in a second field of the block.

2. A method according to claim 1 characterised in that the communication is controlled by the communications network periodically polling the terminals to send acknowledgements of receipt of blocks transmitted by the communications network.

3. A method according to claim 1 or claim 2 characterised in that the first part of the sending permission is sent in a field specifically intended for that information.

4. A method according to claim 3 characterised in that the first field is an uplink state flag field of a MAC header of the block.

5. A method according to any preceding claim characterised in that the second part of the sending permission is sent in a field which is used occasionally to send specific information other than the second part of the sending permission and is not used to send the specific information at other times.

6. A method according to any preceding claim characterised in that the second part of the sending permission is sent in a MAC header of the block.

7. A method according to claim 6 characterised in that the second part of the sending permission is sent in the RRBP field of a downlink RLC/MAC block.

8. A method according to any of claims 1 to 4 characterised in that the second part of the sending permission is sent in an RLC header of the block.

9. A method according to any preceding claim characterised in that the terminals are mobile terminals.

10. A method according to any preceding claim characterised in that at least one of the terminals is a GERAN terminal.

11. A method according to any preceding claim characterised in that the communications network is present in a packet radio system.

12. A method according to any preceding claim characterised in that the communications network is present in a GPRS based system.

13. A communications network for communicating with a plurality of terminals,
wherein at least one of the terminals requests transmission resources from the communications network and the communications network sends a block having a plurality of data fields to the at least one of the terminals the block containing a sending permission to assign the transmission resources and to permit the at least one of the terminals to send data to the communications network,
characterised in that the sending permission has a first part present in a first field of the block and a second part present in a second field of the block.

14. A communications network according to claim 13 characterised in that the network has a protocol stack which generates the sending permission in two parts.

15. A computer program product for operating a communications network, the communications network communicating with a terminal, the computer program product comprising a computer readable medium having thereon:
computer executable code means to enable the communications network to receive a request for transmission resources from the terminal;
computer executable code means to enable the communications network to assign the transmission resources; and
computer executable code means to enable the communications network to send a block having a plurality of data fields to the terminal the block containing a sending permission to permit the terminal to send data to the communications network,
characterised in that the computer program product comprises computer executable code means to enable the communications network to send the sending permission in two parts, a first part present in a first field of the block and a second part present in a second field of the block.

16. A method of operating a terminal to communicate with a communications network, the method comprising the steps of:
requesting transmission resources from the communications network;
receiving an assignment of the transmission resources; and
receiving a block having a plurality of data fields the block containing a sending permission to permit the terminal to send data to the communications network,
characterised in that the sending permission has a first part present in a first field of the block and a second part present in a second field of the block.

17. A terminal for communicating with a communications network, wherein the terminal requests transmission resources from the communications network and the communications network sends a block having a plurality of data fields to the terminal the block containing a sending permission to assign the transmission resources and to permit the terminal to send data to the communications network,
characterised in that the sending permission has a first part present in a first field of the block and a second part present in a second field of the block.

18. A terminal according to claim 17 having a protocol stack which interprets the two part sending permission to determine a single sending permission and then sends data to the network in accordance with the sending permission.

19. A computer program product for operating a terminal to communicate with a communications network, the computer program product comprising a computer readable medium having thereon:
computer executable code means to enable the terminal to send a request for transmission resources from the communications network;
computer executable code means to enable the terminal to receive an assignment of the transmission resources from the communications network; and
computer executable code means to enable the terminal to receive a block having a plurality of data fields from the communications network the block containing a sending permission to permit the terminal to send data to the communications network,
characterised in that the computer program product comprises computer executable code means to enable the terminal to receive the sending permission in two parts, a first part present in a first field of the block and a second part present in a second field of the block.

20. A method of communicating between a terminal and a communications network, the method comprising the step of sending a block having a plurality of data fields from the communications network to the terminal, the block containing an instruction,
characterised in that the instruction has a first part present in a first field of the block and a second part present in a second field of the block wherein the second field is used occasionally to send specific information other than the second part of the instruction and is not used at other times to send the specific information and the second part is sent when the second field is not used to send the specific information.
